(19) United States
(12) Patent Application Publication
(10) Pub. No.: US 2016/0071003 A1
(43) Pub. Date: Mar. 10, 2016

(54) Multilayer Perceptron for Dual SIM Dual Active Interference Cancellation

(71) Applicant: QUALCOMM Incorporated, San Diego, CA (US)

(72) Inventors: Farrokh Abrishamkar, San Diego, CA (US); Sheng-Yuan Tu, San Diego, CA (US); Yin Huang, Beijing (CN); Ori Shental, Tzur Yigal (IL); Insung Kang, San Diego, CA (US)

(21) Appl. No.: 14/510,907

(22) Filed: Oct. 9, 2014

Related U.S. Application Data
(60) Provisional application No. 62/048,519, filed on Sep. 10, 2014.

(51) Int. Cl. G06N 3/04; G06N 3/08

(52) U.S. Cl. CPC G06N 3/04; G06N 3/08

(57) ABSTRACT

The various embodiments include methods and apparatuses for cancelling nonlinear interference during concurrent communication of dual-technology wireless communication devices. Nonlinear interference may be estimated using a multilayer perceptron neural network by augmenting aggressor signal(s) by weight factors, executing a linear combination of the augmented aggressor signals, and executing a nonlinear sigmoid function for the combined aggressor signals at a hidden layer of multilayer perceptron neural network to produce a hidden layer output signal. Multiple hidden layers may repeat the process for the hidden layer output signals. At an output layer, hidden layer output signals may be augmented by weight factors, and the augmented hidden layer output signals may be linearly combined to produce an estimated nonlinear interference used to cancel the nonlinear interference of a victim signal. The weight factors may be trained based on a determination of an error of the estimated nonlinear interference.

### RELATED APPLICATIONS

This application claims the benefit of priority to U.S. Provisional Application No. 62/048,519 entitled “Multilayer Perceptron For Dual Sim Dual Active Interference Cancellation” filed Sep. 10, 2014, the entire contents of which are hereby incorporated by reference.

### BACKGROUND

Some new designs of wireless communication devices—such as smart phones, tablet computers, laptop computers, and routers—contain hardware and/or software elements that provide access to multiple wireless communication networks simultaneously. For example, a wireless communication device can have one or more radio frequency communication circuits (or “RF chains”) for accessing one or more wireless local area networks (“WLANs”), wireless wide area networks (“WWANs”), and/or global positioning systems (“GPS”). When multiple reception (“Rx”) and/or transmission (“Tx”) operations are implemented simultaneously, i.e., co-exist, on a wireless communication device, these operations may interfere with each other.

In a wireless communication device with multiple RF chains, the antennas of the RF chains may be in close proximity to each other. This close proximity may cause one RF chain to desensitize or interfere with the ability of another during the simultaneous use of the RF chains. Receiver desensitization (“desense”), or degradation of receiver sensitivity, may result from noise interference of a nearby transmitter. In particular, when two radios are close together with one transmitting on the uplink (the “aggressor”) and the other receiving on the downlink (the “victim”), signals from the transmitter may be picked up by the receiver or otherwise interfere with reception of a weaker signal (e.g., from a distant base station). As a result, the received signals may become corrupted and difficult or impossible for the victim to decode. In particular, receiver desense presents a design and operational challenge for multi-radio devices due to the proximity of transmitter and receiver.

Nonlinear signals of the RF chains may be to blame for desense. Often the Tx/aggressor signal frequency is a fraction of the Rx/victim signal frequency. However, multiple aggressor signals may constructively combine to form a harmonic aggressor signal to the victim signal. The harmonic aggressor signal may be strong enough to cause nonlinear interference of the victim signal.

Removing nonlinear interference is particularly a problem for multiple RF chain devices, such as dual-SIM dual-active (“DSDA”) devices and for Long-Term Evolution (“LTE”) carrier aggregation. Current implementations of the removing nonlinear interference are case specific, requiring the knowledge of the communication technology used for the transmission and reception of signals, and the kind of interference the aggressor signal is causing.

### SUMMARY

The methods and apparatuses of various embodiments provide circuits and methods for managing interference in a multi-technology communication device. Embodiment methods may include receiving aggressor signals at an input layer of a multilayer perceptron neural network, augmenting the aggressor signals with a weight factor at a first hidden layer of the multilayer perceptron neural network, executing a linear combination of the augmented aggressor signals at the first hidden layer, executing a nonlinear sigmoid function for the combined aggressor signals at the first hidden layer to produce a hidden layer output signal, augmenting the hidden layer output signal with a weight factor at an output layer of the multilayer perceptron neural network, and executing a linear combination of augmented hidden layer output signals at the output layer to produce an estimated nonlinear interference.

Embodiment methods may include training weight factors to reduce an error of the estimated nonlinear interference.

Embodiment methods may include determining an error of the estimated nonlinear interference, determining whether the error of the estimated nonlinear interference exceeds an efficiency threshold, and cancelling the estimated nonlinear interference from a victim signal.

In some embodiments, training weight factors to reduce an error of the estimated nonlinear interference may include training weight factors in response to determining that the error of the estimated nonlinear interference exceeds the efficiency threshold, and cancelling the estimated nonlinear interference from a victim signal may include cancelling the estimated nonlinear interference from the victim signal in response to determining that the error of the estimated nonlinear interference does not exceed the efficiency threshold.

Embodiment methods may include selecting the weight factors to reduce an error of the estimated nonlinear interference.

In some embodiments, selecting the weight factors to reduce an error of the estimated nonlinear interference may include selecting the weight factors used for a previous determination of a previous estimated nonlinear interference for a previous victim signal within a predetermined time period.

In some embodiments, training weight factors to reduce an error of the estimated nonlinear interference may include using the Gauss-Newton algorithm to train the weight factors.

In some embodiments, training weight factors to reduce an error of the estimated nonlinear interference may include using the Levenberg-Marquardt algorithm to train the weight factors.

In some embodiments, executing a linear combination of the augmented aggressor signals at the first hidden layer may include executing a linear combination of the combined aggressor signals and a bias factor at the first hidden layer.

In some embodiments, executing a linear combination of augmented hidden layer output signals at the output layer to produce an estimated nonlinear interference may include executing a linear combination of the combined hidden layer output signals and a bias factor at the output layer.

Embodiment methods may include cancelling the estimated nonlinear interference from a victim signal.

Embodiment methods may include decoding the victim signal after cancelling the estimated nonlinear interference from the victim signal.

Embodiment methods may include augmenting hidden layer output signals with a weight factor at a second hidden layer of the multilayer perceptron neural network, executing a linear combination of the augmented hidden layer output signals at the second hidden layer, and executing a nonlinear sigmoid function for the combined hidden layer output signals at the hidden layer to produce a hidden layer output signal.

Embodiments include a multi-technology communication device having a processor configured with processor-executable instructions to perform operations of one or more of the embodiment methods described above.

Embodiments include a multi-technology communication device having means for performing functions of one or more of the embodiment methods described above.

Embodiments include a non-transitory processor-readable medium having stored thereon processor-executable software instructions to cause a processor to perform operations of one or more of the embodiment methods described above.

### BRIEF DESCRIPTION OF THE DRAWINGS

The accompanying drawings, which are incorporated herein and constitute part of this specification, illustrate exemplary embodiments of the invention, and together with the general description given above and the detailed description given below, serve to explain the features of the invention.

FIG. 1 is a communication system block diagram illustrating a network suitable for use with various embodiments.

FIG. 2 is a component block diagram illustrating various embodiments of a dual-technology wireless communications device.

FIG. 3 is a component block diagram illustrating an interaction between components of different transmit/receive chains in various embodiments of a dual-technology wireless communications device.

FIG. 4 is a component block diagram illustrating a multilayer perceptron neural network in accordance with various embodiments.

FIG. 5 is a component block diagram illustrating a node of a hidden layer of a multilayer perceptron neural network in accordance with various embodiments.

FIG. 6 is a functional block diagram illustrating an interaction between components of a multilayer perceptron neural network in accordance with various embodiments.

FIG. 7 is a process flow diagram illustrating a method for cancelling nonlinear interference using a multilayer perceptron neural network in various embodiments of a dual-technology wireless communications device in accordance with various embodiments.

FIG. 8 is a process flow diagram illustrating a method for estimating nonlinear interference using a multilayer perceptron neural network in a dual-technology wireless communications device in accordance with various embodiments.

FIG. 9 is a process flow diagram illustrating a method for training weight factors for use in a multilayer perceptron neural network in a dual-technology wireless communications device in accordance with various embodiments.

FIG. 10 is a component diagram of an example dual-technology wireless communication device suitable for use with various embodiments.

### DETAILED DESCRIPTION

The various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the invention or the claims.

The word “exemplary” is used herein to mean “serving as an example, instance, or illustration.” Any implementation described herein as “exemplary” is not necessarily to be construed as preferred or advantageous over other implementations.

The terms “computing device,” “mobile device,” and “wireless communication device” are used interchangeably herein to refer to any one or all of cellular telephones, smartphones, personal or mobile multi-media players, personal data assistants (PDAs), laptop computers, tablet computers, smartbooks, ultrabooks, palm-top computers, wireless electronic mail receivers, multimedia Internet enabled cellular telephones, wireless gaming controllers, and similar personal electronic devices which include a memory, a programmable processor and wireless communication circuitry. As used herein, the terms “multi-technology communication device” and “dual-technology communication device” refer to a wireless communication device that includes at least two mobile communication networks. While the various embodiments are particularly useful for mobile devices, such as smartphones, the embodiments are generally useful in any electronic device that implements radio hardware in close proximity to other hardware.

Descriptions of the various embodiments refer to dual-technology communication devices for exemplary purposes, because the embodiments may be suitable for any multiple-technology (multi-technology) wireless communication device that may individually maintain a plurality of connections to a plurality of mobile networks through one or more radio communication circuits. For example, the various embodiments may be implemented in multi-SIM multi-active devices of any combination of number of subscriber identity modules (SIM) and concurrently active subscriptions. Moreover, a SIM may not be required for a wireless communication device to implement the various embodiments, which may apply to any form of wireless communication.

Dual-technology devices enable a user to connect to different mobile networks (or different accounts on the same network) while using the same dual-technology communication device. For example, a dual-technology communication device may connect to GSM, TDSCDMA, CDMA2000, WCDMA and other radio frequency networks. In the various embodiments, dual-technology communication devices may also include two RF chains so that each network communication supported by each RF chain can be accomplished concurrently if interference problems are managed.

Dual-technology devices can suffer from interference between two communications being accomplished concurrently, such as when one communication session is transmitting (“Tx”) at the same time as another RF chain is attempting to receive (“Rx”). As used herein, the term “victim” refers to the communication service or subscription suffering from interference at a given instant, and the term “aggressor” refers to the communication service or subscription whose Rx or Tx actions are causing the interference. In an example dual-technology communication device, the victim may be attempting to receive RF signals from a network while the aggressor attempts to transmit RF signals to another network. In an example of such interference, an aggressor's transmissions may de-sense the victim's reception, in which case the victim may receive the aggressor's transmissions that act as noise and interfere with the victim's ability to receive wanted RF signals.

In dual-technology communication devices, an aggressor's transmissions may cause severe impairment to the victim's ability to receive transmission. This interference may be in the form of blocking interference, harmonics, intermodulation, and other noises and distortion. Such interference may significantly degrade the victim's receiver sensitivity, link to a network, voice call quality and data throughput. These effects may result in a reduced network capacity for the affected communication service or subscription. The aggressor's transmission may also cause the victim to experience a receiver sensitivity that is drastically degraded, call quality degradation, higher rates for call drops and radio link failures, and data throughput degradation, which may potentially cause the victim to lose a data connection.

The various embodiments include methods for removing nonlinear interference in digital communications by using a neural network analysis method to determine the coefficients of the signal to be removed before a received signal is decoded. In particular, the neural network may implement supervised learning using multilayer perceptrons to dynamically estimate an interference of the aggressor signals on the victim signal to be removed from the victim signal so that it may be decoded.

In various embodiments, a mobile device may use the neural network method to estimate a function of the nonlinear interference from a set of known aggressor reference signals and a victim reference signal without having to know the type of communication technology or type of interference. The set of aggressor reference signals may be obtained from the RF chain on the mobile device transmitting the aggressor reference signals. The victim reference signal may be obtained from the RF chain on the mobile device receiving the victim reference signal. These known signals may be received by the neural network at an input layer. From the input layer the neural network may pass the aggressor reference signals to a hidden layer of the neural network. In passing these signals to nodes of the hidden layer, the aggressor reference signals may be augmented using weight factors. The augmented aggressor reference signals may be linearly combined for each node of the hidden layer and the result may be augmented by a nonlinear sigmoid function. The output of the hidden layer may be passed to a next hidden layer to go through similar augmentation, linear combination, and nonlinear augmentation. There may be any number of hidden layers. An output of a final hidden layer may be passed to an output layer where all of the outputs of the final hidden layer are again augmented by weight factors and linearly combined. An output of the output layer may be an estimation of a victim signal having an estimated nonlinear interference, from which a function of the nonlinear interference may be determined. A result of the estimated function of the nonlinear interference may be used to remove an estimated nonlinear interference from a received victim signal.

In various embodiments, the weight factors used to estimate the function of the nonlinear interference may be trained using the victim reference signal and an estimated victim signal using the estimated nonlinear interference to calculate the error between the victim reference signal and the estimated victim signal. The trained weight factors may be updated in the neural network to increase the accuracy of the estimated nonlinear interference. The accuracy of the estimated nonlinear interference may be correlated with a number of hidden layers of the neural network.

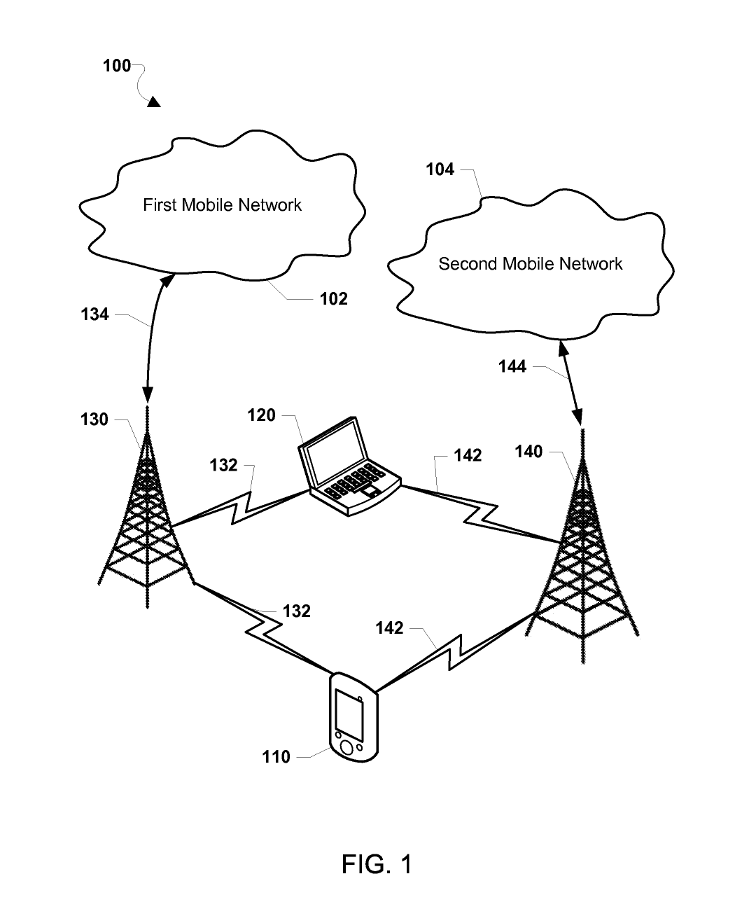

The various embodiments may be implemented in wireless communication devices that operate within a variety of communication systems 100, such as at least two mobile telephony networks, an example of which is illustrated in FIG. 1. A first mobile network 102 and a second mobile network 104 are typical mobile networks that include a plurality of cellular base stations 130 and 140. A first dual-technology communication device 110 may be in communication with the first mobile network 102 through a cellular connection 132 to a first base station 130. The first dual-technology communication device 110 may also be in communication with the second mobile network 104 through a cellular connection 142 to a second base station 140. The first base station 130 may be in communication with the first mobile network 102 over a connection 134. The second base station 140 may be in communication with the second mobile network 104 over a connection 144.

A second dual-technology communication device 120 may similarly communicate with the first mobile network 102 through a cellular connection 132 to a first base station 130. The second dual-technology communication device 120 may communicate with the second mobile network 104 through a cellular connection 142 to the second base station 140. Cellular connections 132 and 142 may be made through two-way wireless communication links, such as 4G, 3G, CDMA, TDSCDMA, WCDMA, GSM, and other mobile telephony communication technologies. Other connections may include various other wireless connections, including WLANs, such as Wi-Fi based on IEEE 802.11 standards, and wireless location services, such as GPS.

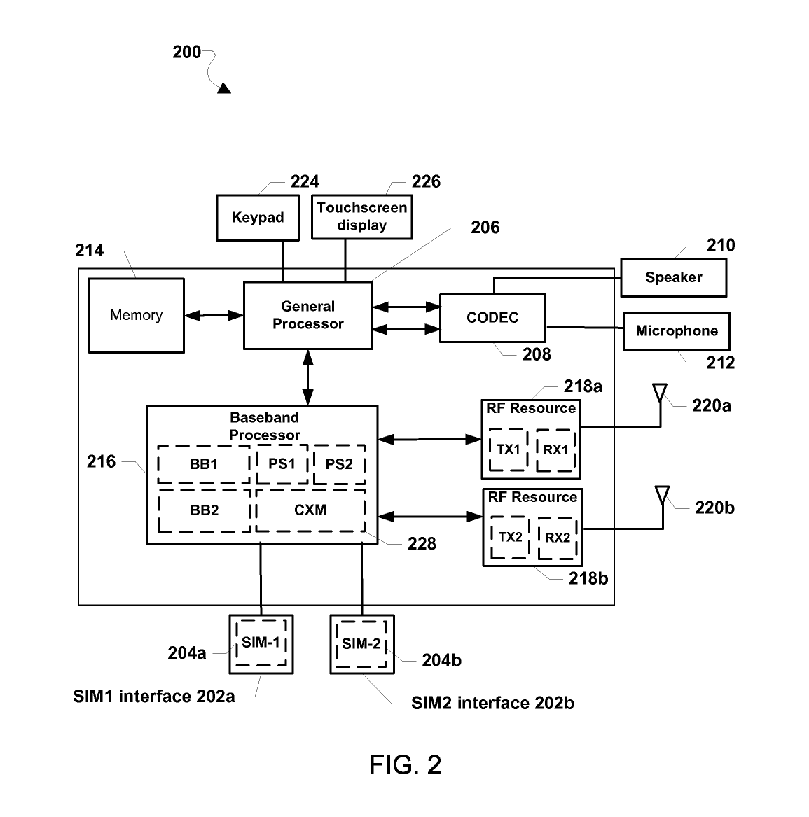

FIG. 2 illustrates various embodiments of a dual-technology communication device 200 (e.g., 110, 120 in FIG. 1) that are suitable for implementing the various embodiments. With reference to FIGS. 1 and 2, the dual-technology communication device 200 may include a first SIM interface 202a, which may receive a first identity module SIM-1 204a that is associated with the first subscription. The dual-technology communication device 200 may also include a second SIM interface 202b, which may receive a second identity module SIM-2 204b that is associated with the second subscription.

A SIM in the various embodiments may be a Universal Integrated Circuit Card (UICC) that is configured with SIM and/or USIM applications, enabling access to, for example, GSM and/or UMTS networks. The UICC may also provide storage for a phone book and other applications. Alternatively, in a CDMA network, a SIM may be a UICC removable user identity module (R-UIM) or a CDMA subscriber identity module (CSIM) on a card.

Each SIM may have a CPU, ROM, RAM, EEPROM and I/O circuits. A SIM used in the various embodiments may contain user account information, an international mobile subscriber identity (IMSI), a set of SIM application toolkit (SAT) commands and storage space for phone book contacts. A SIM may further store a Home Public-Land-Mobile-Network (HPLMN) code to indicate the SIM card network operator provider. An Integrated Circuit Card Identity (ICCID) SIM serial number may be printed on the SIM for identification.

Each dual-technology communication device 200 may include at least one controller, such as a general purpose processor 206, which may be coupled to a coder/decoder (CODEC) 208. The CODEC 208 may in turn be coupled to a speaker 210 and a microphone 212. The general purpose processor 206 may also be coupled to at least one memory 214. The memory 214 may be a non-transitory tangible computer readable storage medium that stores processor-executable instructions. For example, the instructions may include routing communication data relating to the first or second subscription though a corresponding baseband-RF resource chain.

The memory 214 may store operating system (OS), as well as user application software and executable instructions. The memory 214 may also store application data, such as an array data structure.

The general purpose processor 206 and memory 214 may each be coupled to at least one baseband modem processor 216. Each SIM in the dual-technology communication device 200 (e.g., SIM-1 202a and SIM-2 202b) may be associated with a baseband-RF resource chain. Each baseband-RF resource chain may include the baseband modem processor 216 to perform baseband/modem functions for communications on a SIM, and one or more amplifiers and radios, referred to generally herein as RF resources 218a, 128b. In some embodiments, baseband-RF resource chains may interact with a shared baseband modem processor 216 (i.e., a single device that performs baseband/modem functions for all SIMs on the wireless device). Alternatively, each baseband-RF resource chain may include physically or logically separate baseband processors (e.g., BB1, BB2).

In some embodiments, the baseband modem processor 216 may be an integrated chip capable of managing the protocol stacks of each of the SIMs or subscriptions (e.g., PS1, PS1) and implementing a co-existence manager software 228 (e.g., CXM). By implementing modem software, subscription protocol stacks, and the co-existence manager software 228 on this integrated baseband modem processor 216, thread based instructions may be used on the integrated baseband modem processor 216 to communicate instructions between the software implementing the interference prediction, the mitigation techniques for co-existence issues, and the Rx and Tx operations.

The RF resources 218a, 218b may be communication circuits or transceivers that perform transmit/receive functions for the associated SIM of the wireless device. The RF resources 218a, 218b may be communication circuits that include separate transmit and receive circuitry, or may include a transceiver that combines transmitter and receiver functions. The RF resources 218a, 218b may be coupled to a wireless antenna (e.g., a first wireless antenna 220a and a second wireless antenna 220b). The RF resources 218a, 218b may also be coupled to the baseband modem processor 216.

In some embodiments, the general purpose processor 206, memory 214, baseband processor(s) 216, and RF resources 218a, 218b may be included in the dual-technology communication device 200 as a system-on-chip. In other embodiments, the first and second SIMs 202a, 202b and their corresponding interfaces 204a, 204b may be external to the system-on-chip. Further, various input and output devices may be coupled to components on the system-on-chip, such as interfaces or controllers. Example user input components suitable for use in the dual-technology communication device 200 may include, but are not limited to, a keypad 224 and a touchscreen display 226.

In some embodiments, the keypad 224, touchscreen display 226, microphone 212, or a combination thereof, may perform the function of receiving the request to initiate an outgoing call. For example, the touchscreen display 226 may receive a selection of a contact from a contact list or receive a telephone number. In another example, either or both of the touchscreen display 226 and microphone 212 may perform the function of receiving a request to initiate an outgoing call. For example, the touchscreen display 226 may receive selection of a contact from a contact list or to receive a telephone number. As another example, the request to initiate the outgoing call may be in the form of a voice command received via the microphone 212. Interfaces may be provided between the various software modules and functions in dual-technology communication device 200 to enable communication between them, as is known in the art.

In some embodiments, the dual-technology communication device 200 may instead be a single-technology or multiple-technology device having more or less than two RF chains. Further, various embodiments may implement, single RF chain or multiple RF chain wireless communication devices with fewer SIM cards than the number of RF chains, including without using any SIM card.

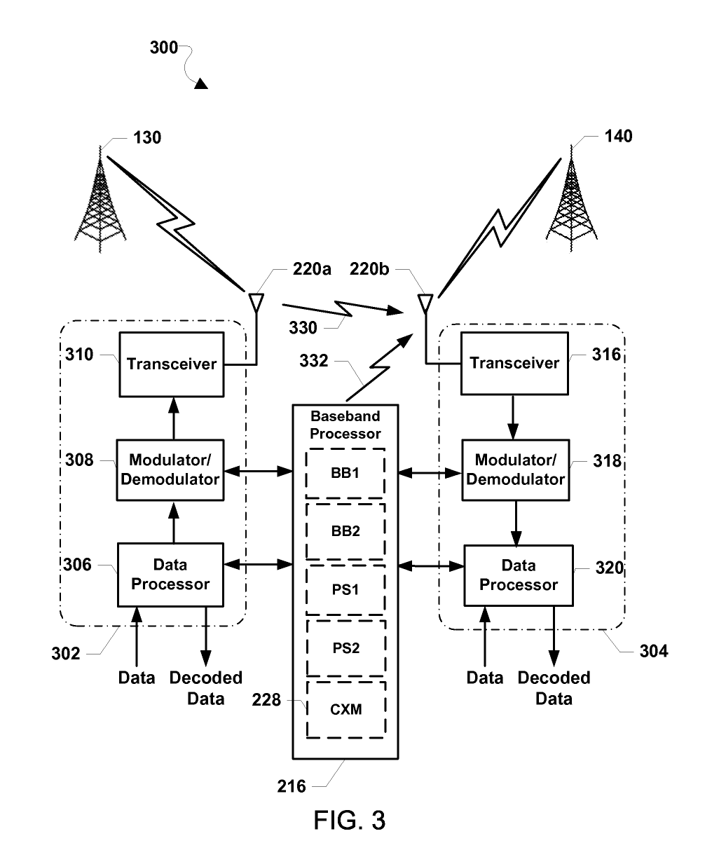

FIG. 3 illustrates embodiment interactions between components of different transmit/receive chains in a dual-technology wireless communications device. With reference to FIGS. 1-3, for example, a first radio technology RF chain 302 may be one RF resource 218a, and a second radio technology RF chain 304 may be part of another RF resource 218b. In some embodiments, the first and second radio technology RF chains 302, 304 may include components operable for transmitting data. When transmitting data, a data processor 306, 320 that may format, encode, and interleave data to be transmitted. A modulator/demodulator 308, 318 may modulate a carrier signal with encoded data, for example, by performing Gaussian minimum shift keying (GMSK). One or more transceiver circuits 310, 316 may condition the modulated signal (e.g., by filtering, amplifying, and up-converting) to generate a RF modulated signal for transmission. The RF modulated signal may be transmitted, for example, to the base station 130, 140 via an antenna, such as the antenna 220a, 220b.

The components of the first and second radio technology RF chains 302, 304 may also be operable to receive data. When receiving data, the antenna 220a, 220b may receive RF modulated signals from the base station 130, 140 for example. The one or more transceiver circuits 310, 316 may condition (e.g., filter, amplify, and down-convert) the received RF modulated signal, digitize the conditioned signal, and provide samples to the modulator/demodulator 308, 318. The modulator/demodulator 308, 318 may extract the original information-bearing signal from the modulated carrier wave, and may provide the demodulated signal to the data processor 306, 320. The data processor 306, 320 may de-interleave and decode the signal to obtain the original, decoded data, and may provide decoded data to other components in the wireless device.

Operations of the first and second radio technology RF chains 302, 304 may be controlled by a processor, such as the baseband processor(s) 216. In the various embodiments, each of the first and second radio technology RF chains 302, 304 may be implemented as circuitry that may be separated into respective receive and transmit circuits (not shown). Alternatively, the first and second radio technology RF chains 302, 304 may combine receive and transmit circuitry (e.g., as transceivers associated with SIM-1 and SIM-2 in FIG. 2).

As described, interference between the first and second radio technology RF chains 302, 304, such as de-sense and interpolation, may cause the desired signals to become corrupted and difficult or impossible to decode. For example, a transmission signal 330 sent by the first radio technology RF chain 302 may be errantly received by the second radio technology RF chain 304. To avoid such interference, the dual-technology communication device may implement various embodiment algorithms to estimate a nonlinear interference caused by the transmissions signal 330 and cancel the estimated nonlinear interference from signals received by the second radio technology RF chain 304.

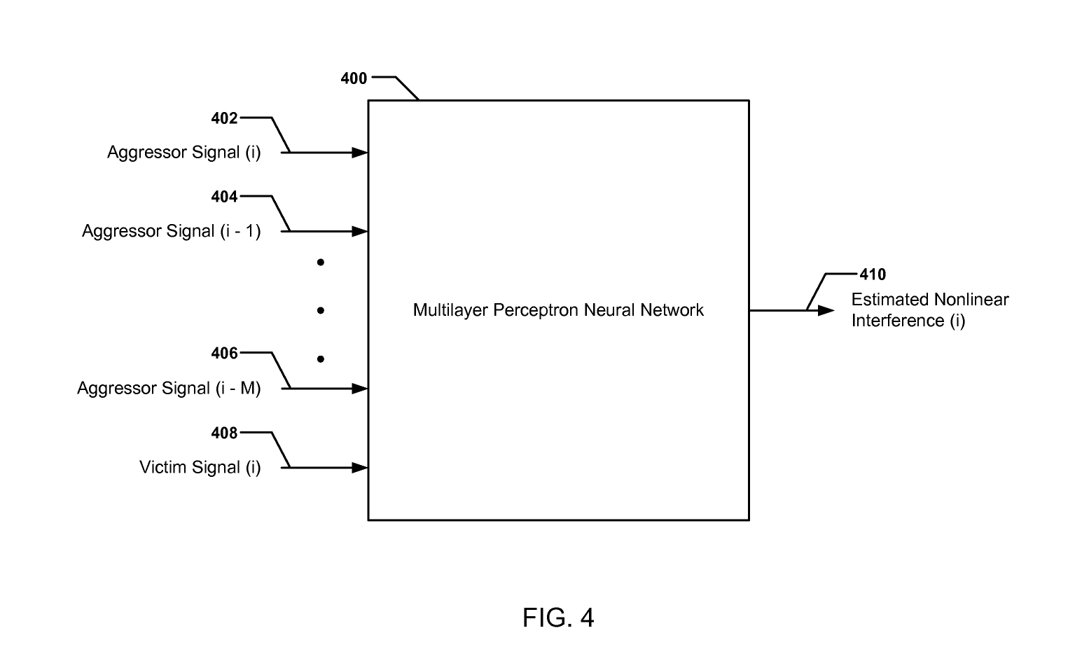

FIG. 4 illustrates a multilayer perceptron neural network 400 implemented in a dual-technology wireless communications device (e.g., 110, 120, 200 in FIGS. 1 and 2) in accordance with various embodiments. With reference to FIGS. 1-4, the multilayer perceptron neural network 400 may be implemented in software, general processing hardware, dedicated hardware, or a combination of any of the preceding. The multilayer perceptron neural network 400 may be configured to receive an aggressor signal 402 and a victim signal 408 for a time “i”. The multilayer perceptron neural network 400 may be configured to receive one or more previous aggressor signals 404, 406 stored in a memory (e.g. 214) having “M” number of stored previous aggressor signals. The previous aggressor signals 404, 406 may be selected from a set of stored previous aggressor signals, based on various criteria, such as number of pervious aggressor signals stored or requested, a time period from which the previous aggressor signal were recorded, or a time interval between previous aggressor signals. The multilayer perceptron neural network 400 may be configured to calculate an estimated nonlinear interference signal 410 for the time “i”.

The aggressor signals 402, 404, 406 received by the multilayer perceptron neural network 400 may be represented as a function z(i) for the time “i”. Thus, the set of received aggressor signals 402, 404, 406 for the time “i”, including the aggressor signal 402 for the time “i” up to “M” previous aggressor signals 404, 406, may be represented by the following function:

Z(i)=[z(i),z(i−1), . . . ,z(i−M)]

A nonlinear interference signal caused by the aggressor signal(s) 402, 404, 406 on the victim signal 408 may be represented as a function y(i) for the time “i”. The function y(i) may be expressed in terms of a function l of the set of aggressor signal(s) 402, 404, 406 and an error vector magnitude ΔZ(i) of the aggressor signal(s) 402, 404, 406. The nonlinear interference signal for the time “i” may be represented by the following function:

y(i)=l(Z(i)+ΔZ(i))

The victim signal 408 for the time “i” received by the multilayer perceptron neural network 400 may be represented as a function q(i) for the time “i”. The function q(i) may be expressed in terms of elements of the victim signal including a signal-to-noise ratio (SNR), a jammer-to-noise ratio (JNR), the intended receive signal represented as a function x(i) for the time “i”, the nonlinear interference signal, and a noise in the victim signal 408, such as thermal noise an inter-device interference, represented by the function v(i) for the time “i”. The victim signal 408 for the time “i” may be represented by the following function:

q(i)=\sqrt{SNR}·x(i)+\sqrt{JNR}·l(Z(i)+ΔZ(i)+v(i)

In some embodiments, the multilayer perceptron neural network 400 may be implemented in a dual-technology wireless communications device to help identify the intended receive signal x(i) from among the elements of the victim signal 408 q(i). Given one or more aggressor signals 402, 404, 406, the multilayer perceptron neural network 400 may calculate the estimated nonlinear interference signal 410 for time “i” so that the estimated nonlinear interference signal 410 may be cancelled from the victim signal 408 q(i). The estimated nonlinear interference signal 410 may be expressed as an estimated Y(i) for the time “i”. The estimated function Y(i) may be expressed in terms of an estimated function L of the set of aggressor signal(s) 402, 404, 406. The estimated nonlinear interference signal 410 for the time “i” may be represented by the following function:

Y(i)=L(Z(i))

The estimated function Y(i) is an estimate of the nonlinear interference signal y(i).

Calculating the estimated nonlinear interference signal 410 for the time “i” may be accomplished by the multilayer perceptron neural network 400 in a blind and universal manner. In other words, the multilayer perceptron neural network 400 may calculate the estimated nonlinear interference signal 410 without knowing the radio access technology used by the dual-technology wireless communications device or the kind of interference occurring on the victim signal. The multilayer perceptron neural network 400 may calculate the estimated nonlinear interference signal 410 knowing the aggressor signal(s) 402, 404, 406 and the victim signal 408. The multilayer perceptron neural network 400 may be trained to learn the kind of interference that the aggressor signal(s) 402, 404, 406 are causing on the victim signal 408.

Nonlinear interference may be cumulative over time cause by the set of aggressor signals 402, 404, 406. The dual-technology wireless communications device may include a memory or portion of memory for storing pervious aggressor signals so that this information may be used in calculating the estimated nonlinear interference signal 410 for time “i”. As described, the memory may store “M” number of previous aggressor signals 404, 406, and the “M” number of stored previous aggressor signals 404, 406 may define how many previous aggressor signals 404, 406 may be used to calculate the estimated nonlinear interference signal 410.

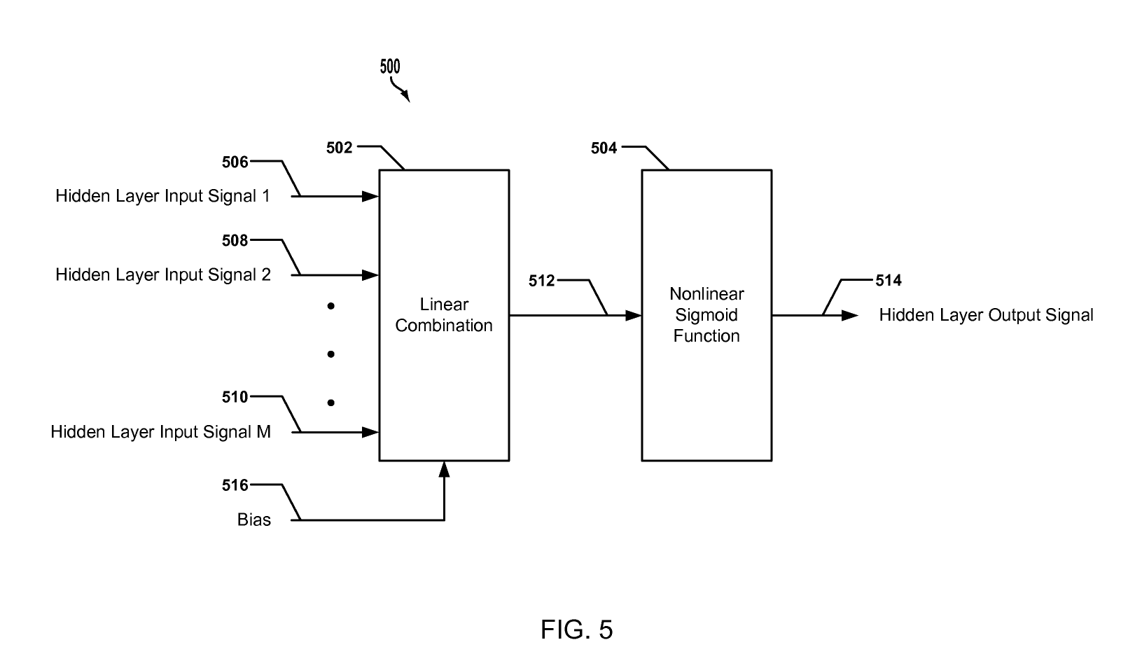

FIG. 5 illustrates a node 500 of a hidden layer of the multilayer perceptron neural network (e.g., 400 in FIG. 4) in accordance with various embodiments. With reference to FIGS. 1-5, the multilayer perceptron neural network may include one or more hidden layers which may further the calculation of the estimated nonlinear interference signal for time “i”. Each hidden layer may include one or more nodes 500. The number of nodes may be dictated by the number of hidden layer input signals 506, 508, 510 that may be provided to the hidden layer from an input layer or a pervious hidden layer. In some embodiments, the “M” number of stored previous aggressor signals that are stored in memory together with the aggressor signal at time “i” may be the hidden layer input signals 506, 508, 510 from the input layer and may dictate the number of nodes in the hidden layer. Each node 500 may also produce a hidden layer output signal 514, which may be used as a hidden layer input signal 506, 508, 510 for a subsequent hidden layer or as an output layer input signal.

Each node 500 may receive the hidden layer input signals 506, 508, 510. As discussed further herein, the hidden layer input signals 506, 508, 510, be they from the input layer or from a previous hidden layer, may be augmented by a weight factor. The node 500 may include a linear combination component 502 that may be implemented with general processing hardware, dedicated processing hardware, and/or software. The linear combination component 502 may receive the hidden layer input signals 506, 508, 510 and a bias 516, as described further herein, and combine them into a hidden layer intermediate signal 512. The resulting hidden layer intermediate signal 512 may be represented as a function yₖ^{r}(i) at current layer node “k” and current layer “r” for the time “i”. The function yₖ^{r}(i) may be expressed in terms of the linear combination of the hidden layer input signals 506, 508, 510 and the bias 516.

The hidden layer input signals 506, 508, 510 may each be represented as a function φⱼ^{r-1}(i) at a previous layer “r-1” and previous layer node “j” for the time “i”. Note that the function for the hidden layer input signals 506, 508, 510 may be the same function for the output layer input signals.

The weight factor that may augment the hidden layer input signals 506, 508, 510 may be represented as a term w_{k,j}^{r} for a weight factor “w” from previous layer node “j” to current layer node “k” at current layer “r”. The bias 516 may be similar to the weight factor and may be represented as a term w_{k,0}^{r} for a weight factor “w” from previous layer node “j”=0 to current layer node “k” at current layer “r”. The previous layer node “j”=0 may indicate that there may be no previous layer node or the bias 516 may be determined from a fixed previous layer node “j”.

The linear combination of the elements of the hidden layer intermediate signal 512 may include a summation of the hidden layer input signals 506, 508, 510 augmented by the weight factors form the first previous layer node “j”=1 to the total number of nodes at the previous layer “Kᵣ₋₁”. The summation of the augmented hidden layer input signals 506, 508, 510 may be further modified by combining it with the bias 516. The hidden layer intermediate signal 512 at current layer node “k” and current layer “r” for the time “i” may be represented by the following function:

$${y}_{k}^{r} ( i ) = {\sum }_{j = 1}^{{K}_{r - 1}} {w}_{k , j}^{r} {φ}_{j}^{r - 1} ( i ) + {w}_{k , 0}^{r}$$

The node 500 may further include a nonlinear sigmoid function component 504 which may be implemented with general processing hardware, dedicated processing hardware, and/or software. The nonlinear sigmoid function component 504 may receive the hidden layer intermediate signal 512 from the linear combination component 502 and execute a nonlinear sigmoid function, for example a hyperbolic tangent function, using the hidden layer intermediate signal 512. The sigmoid function may be represented as a function σ(yₖ^{r}(i)).

A result of the nonlinear sigmoid function may be used as the hidden layer output signal 514. As discussed, the hidden layer output signal 514 may be used as a hidden layer input signal 506, 508, 510 for a subsequent hidden layer or as an output layer input signal. As the hidden layer output signal 514 may be used as an input signal for other layers of the multilayer perceptron neural network, the hidden layer output signal 514 may be represented using a similar function to the hidden layer input signal 506, 508, 510 and the output layer input signal except at the current layer outputting the hidden layer output signal 514, φₖ^{r}(i) at current layer “r” and current layer node “k” for the time “i”. Thus, the hidden layer output signal 514 may be represented using the following function:

φₖ^{r}(i)=σ(yₖ^{r}(i))

In some embodiments, the nonlinear sigmoid function component 504 may be implemented using a table of precalculated results of applying the nonlinear sigmoid function to various potential values of the hidden layer intermediate signal 512. The nonlinear sigmoid function component 504 may retrieve the nonlinear sigmoid function value associated with a hidden layer intermediate signal value in the table and produce the nonlinear sigmoid function value as the hidden layer output signal 514.

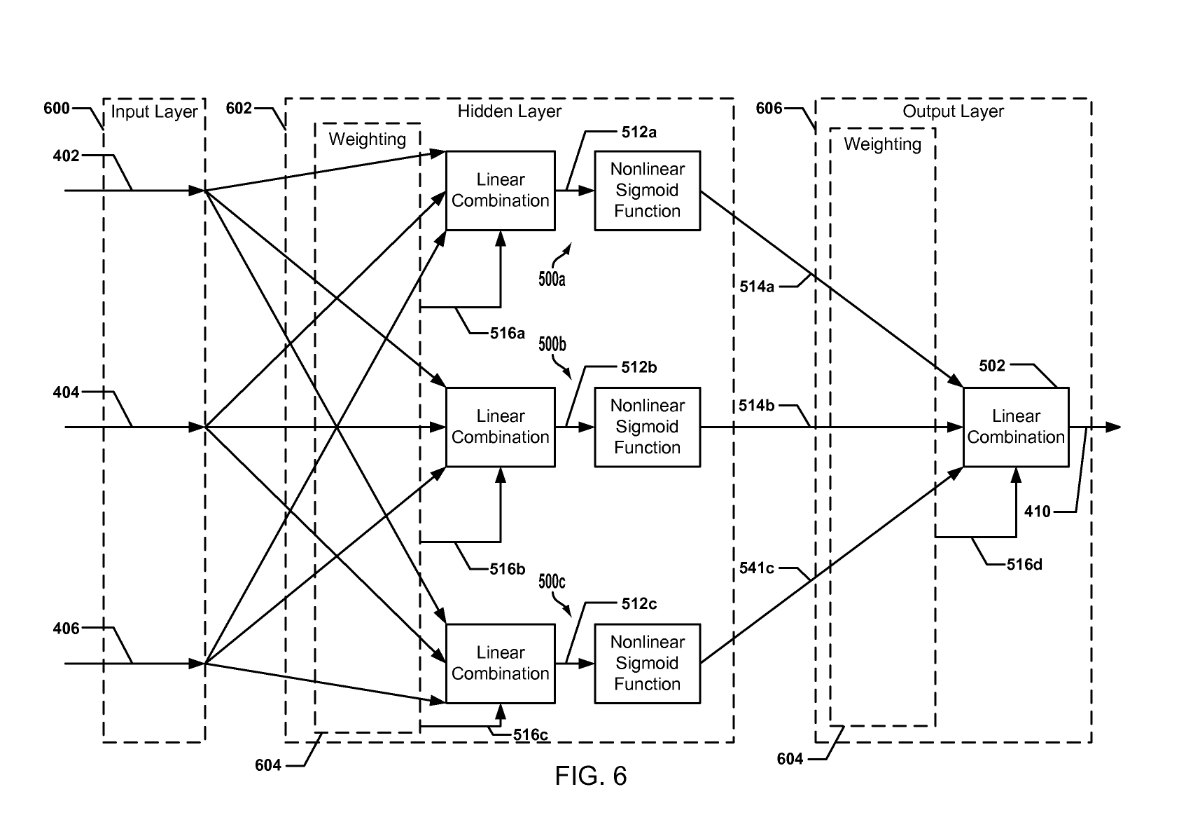

FIG. 6 illustrates interactions between components of a multilayer perceptron neural network (e.g., 400 in FIG. 4) in accordance with various embodiments. With reference to FIGS. 1-6, the multilayer perceptron neural network may include an input layer 600, one or more hidden layers 602, and an output layer 606. The illustrated example displays one hidden layer 602 for simplicity of explanation. However, it should be understood that the multilayer perceptron neural network may not be limited to having just one hidden layer 602, but may include multiple successive hidden layers 602.

The input layer 600 may receive the aggressor signals 402, 404, 406 and pass them to the (first) hidden layer 602. Each of the aggressor signals 402, 404, 406 may be passed to and received by each node 500a, 500b, 500c of the first hidden layer 602.

The aggressor signals 402, 404, 406 may be augmented by a weighting component 604, which may apply a weight factor to each of the aggressor signals 402, 404, 406. The weighting component 604 may also provide a bias 516a, 516b, 516c to each linear combination component of each node 500a, 500b, 500c. The weighting component 604 may be an individual component of the multilayer perceptron neural network implemented with general purpose hardware, dedicated hardware, and/software, or the weighting component 604 may be incorporated into the linear combination component. The weighting component 604 may apply an initial weight factor to the aggressor signals 402, 404, 406 from the input layer that are preprogrammed and configured to reduce the error in the nonlinear interference function estimation.

The initial weight factors may be selected at random from within a range of values for the initial weight factors, such as a range of about −0.5 to about 0.5 (or other suitable range). In some embodiments, the initial weight factors may be selected based on historical performance of previous weight factors to reduce the error in the nonlinear interference function estimation. As will be discussed in further detail, the weighting component may train the weight factors at different times to improve the nonlinear interference function estimation.

The nodes 500a, 500b, 500c may execute a linear combination of the aggressor signals 402, 404, 406 augmented with the weight factors and the bias 516a, 516b, 516c to produce the hidden layer intermediate signals 512a, 512b, 512c. The nodes 500a, 500b, 500c may execute the nonlinear sigmoid function for the hidden layer intermediate signals 512a, 512b, 512c to produce the hidden layer output signals 514a, 514b, 514c. In embodiments including multiple hidden layers 602, a successive hidden layer may receive the hidden layer output signals 514a, 514b, 514c from the first hidden layer 602, and treat the hidden layer output signals 514a, 514b, 514c in a similar manner as the first hidden layer 602 may treat the aggressor signals 402, 404, 406. Each hidden layer output signal 514a, 514b, 514c may be received by each node of the successive hidden layer. The hidden layer output signals 514a, 514b, 514c may be augmented by a weighting component, which may apply a weight factor to each of the hidden layer output signals 514a, 514b, 514c. The augmented hidden layer output signals 514a, 514b, 514c and a bias may be linearly combined to produce a hidden layer intermediate signal, which may be used by a nonlinear sigmoid function to produce a successive set of hidden layer output signals.

These interactions of the components of the multilayer perceptron neural network may repeat between any number of successive hidden layers. A level of accuracy for the estimated nonlinear interference function may be influenced by the number of hidden layers used by the multilayer perceptron neural network.

A last hidden layer of the multilayer perceptron neural network, which is the hidden layer 602 in the illustrated example, may pass its hidden layer output signals 514a, 514b, 514c to an output layer 606. The hidden layer output signals 514a, 514b, 514c may be received by a single node of the output layer 606, which may include a similar weighting component 604 and a linear combination component 502. As in the hidden layer 602, the weighting component 604 of the output layer 606 may augment each of the received hidden layer output signals 514a, 514b, 514c with a weight factor and provide the linear combination component 502 with a bias 516d.

The linear combination component 502 may execute a linear combination of the augmented hidden layer output signals 514a, 514b, 514c and the bias 516d. In other words, the output layer 606 may produce an estimated nonlinear interference 410 according to the same function of the hidden layer intermediate signal represented as yₖ^{r}(i) at current layer node “k” and current layer “r” for the time “i”.

The estimated nonlinear interference 410 may be used for multiple purposes by a dual-technology communications device. In some embodiments, the estimated nonlinear interference 410 may be cancelled or subtracted from the victim signal 408 so that the victim signal 408 may be decoded and understood by the dual-technology communications device. In some embodiments, the estimated nonlinear interference 410 may be used to train the weight factors of the multilayer perceptron neural network to improve the accuracy of the estimated nonlinear interference 410. An error level in estimating the nonlinear interference on the victim signal 408 may be determined by a function comparing the estimated nonlinear interference 410 with a measured interference of the victim signal 408. The error may be calculated for any of the weight factors and may be represented as the following function:

J(w_{k,j}^{r})=½(Y(i)−y(i))²

In some embodiments, the error of the estimated nonlinear interference 410 may be compared to an error threshold to determine whether the error is acceptable. Determining that the error is unacceptable may prompt the multilayer perceptron neural network to train the weight factors to improve the error in the estimated nonlinear interference 410. The weight factors may be trained using a variety of optimization algorithms, for example gradient decent, the Gauss-Newton algorithm, and the Levenberg-Marquardt algorithm. Training of the weight factors may be regressively executed to further reduce the error of the estimated nonlinear interference 410. In some embodiments, satisfactory weight factors may be reused for subsequent estimations of the nonlinear interference. The reuse of previously determined weight factors may be based on one or more parameters, such as time since the last adjustment of the weight factors, efficiency of the weight factors, how the error in the estimated nonlinear interference 410 compares to the error threshold, and/or the like.

In the various examples, various components of the multilayer perceptron neural network are shown individually or in combination. It should be understood that these examples are not limiting and the various other configurations of the components are considered. For example, the nodes 500a, 500b, 500c and their components are illustrated as separate components. However, any of the nodes 500a, 500b, 500c and/or components may be embodied in combination with other components, and multiples of the same component may be embodied in a single component.

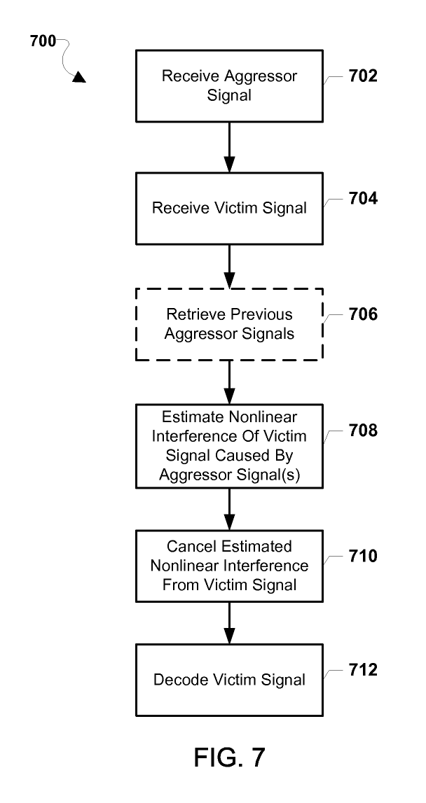

FIG. 7 illustrates a method 700 for cancelling nonlinear interference using a multilayer perceptron neural network (e.g., 400 in FIG. 4) in a dual-technology wireless communications device in accordance with various embodiments. The method 700 may be executed in a computing device (e.g., 110, 120, 200 in FIGS. 1 and 2) using software, general purpose or dedicated hardware, or a combination of software and hardware, such as the general purpose processor 206 (FIG. 2), baseband processor 216, or the like. With reference to FIGS. 1-7, in block 702, the dual-technology communication device may receive an aggressor signal. The aggressors signal may be received by a first radio access technology of the dual-technology communication device from a transmission of a second radio access technology of the same dual-technology communication device.

In block 704, the dual-technology communication device may receive a victim signal. The victim signal may be received by the first radio access technology of the dual-technology communication device from a transmitting source device separate from the dual-technology communication device. The victim signal may initially be a transmission sent from the transmitting source device that is unaffected by the interference caused by the aggressor signal during the transmission to the dual-technology communication device. Interference caused by the aggressor signal while receiving the transmission signal by the dual-technology communication device may cause the transmission signal to become the victim signal.

In optional block 706, the dual-technology communication device may retrieve previous aggressor signals from memory. As described, nonlinear interference by the aggressor signals on any victim signal may be cumulative over time. Previous aggressor signals may be stored in memory for use in calculating the estimated nonlinear interference to cancel from the victim signal. In some embodiments, retrieving the previous aggressor signals is optional as a victim signal may be affected by an aggressor signal before there has been an opportunity to store any previous aggressor signals. For example, the first radio access technology may be in an inactive state until the first radio access technology is activated to receive the victim signal. Having been previously inactive for a period, the first radio access technology may not be affected by previous aggressor signals. In similar embodiments, the second radio access technology may be in an inactive state. The second radio access technology may be activated while the first radio access technology receives transmission signals, thereby transmitting aggressor signals and causing interference on the victim signal without previous aggressor signals existing for a time period. In some embodiments, the dual-technology communication device may use only the current aggressor signal or a selection of previous aggressor signals stored in the memory.

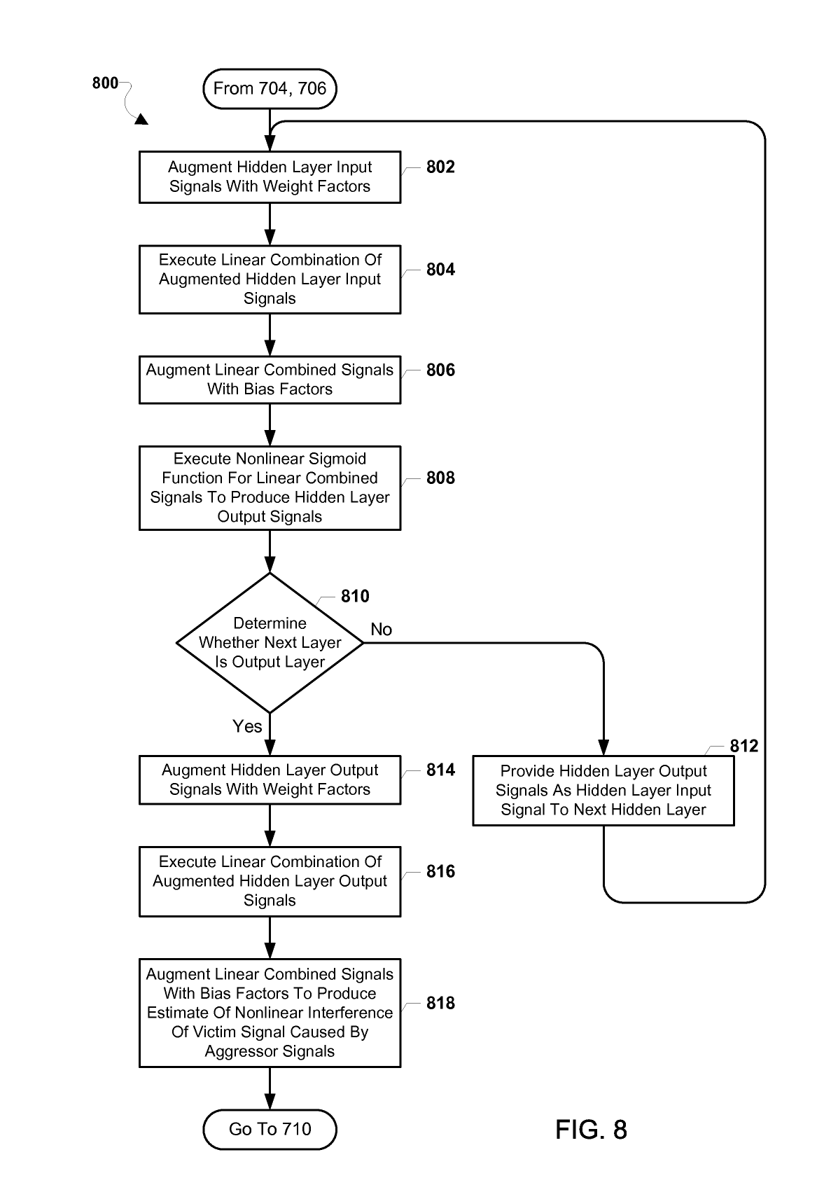

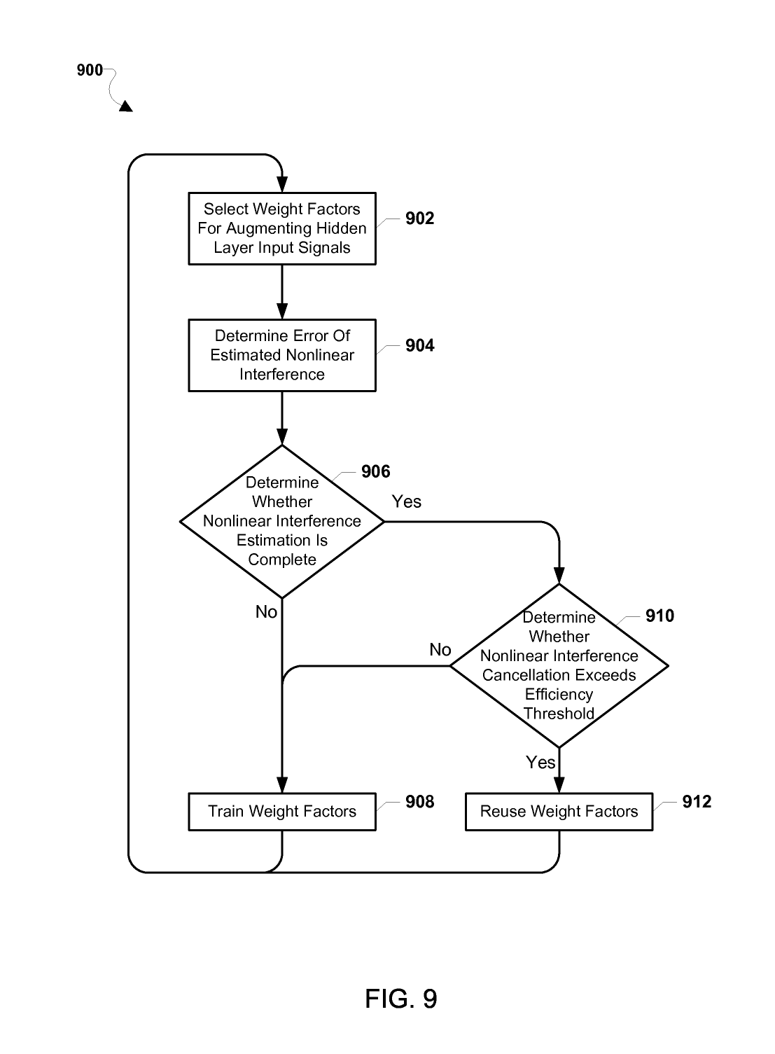

In block 708, the dual-technology communication device may estimate the nonlinear interference of the victim signal caused by the aggressor signal(s). This estimation of the nonlinear interference is discussed in further detail (e.g., with reference to FIGS. 8 and 9). In block 710, the dual-technology communication device may cancel the estimated nonlinear interference from the victim signal. Cancelling or removing the estimated nonlinear interference from the victim signal may be implemented in a variety of known ways, such as filtration, transformation, extraction, reconstruction, and suppression. In block 712, the dual-technology communication device may decode the victim signal without the interference by the aggressor signal(s).

FIG. 8 illustrates a method 800 for estimating nonlinear interference using a multilayer perceptron neural network (e.g., 400 in FIG. 4) in a dual-technology wireless communications device in accordance with various embodiments. The method 800 may be executed in a computing device (e.g., 110, 120, 200 in FIGS. 1 and 2) using software, general purpose or dedicated hardware, or a combination of software and hardware, such as the general purpose processor 206 (FIG. 2), baseband processor 216, or the like. The method 800 may be included in method 700 in FIG. 7 as part of block 708. As described, the victim signal and the aggressor signal(s) may be used by the dual-technology communication device as input signals for the multilayer perceptron neural network. The victim signal and the aggressor signal(s) may be received by the input layer of the multilayer perceptron neural network. The aggressor signal(s) may be used as hidden layer input signals for calculating the estimated nonlinear interference.

With reference to FIGS. 1-8, in block 802 the dual-technology communication device may augment the hidden layer input signals with weight factors. As described, in various embodiments, the weight factors may determine at random, be preprogrammed, and/or trained as described with reference to FIG. 9. In some embodiments, weight factors may be determined based on the previous node and layer from which the hidden layer input signals are output.

In block 804, the dual-technology communication device may execute a linear combination of the hidden layer input signals augmented by the weight factors. In block 806, the dual-technology communication device may execute a linear combination for the linearly combined hidden layer input signals with a bias factor. In some embodiments, the bias factor may be determined based on the node and layer receiving the hidden layer input signals. In some embodiments, the augmentation and linear combination may be executed through mathematical and/or logical operations. The operations implementing the augmentation may result in a multiplication of a respective weight factor with a respective hidden layer input signal. The operations implementing the linear combination may result in the summation of the augmented hidden layer input signals and the bias factor. The linear combination of the augmented hidden layer input signals and the bias factor may be labeled as the hidden layer intermediate signal.

In block 808, the dual-technology communication device may execute a nonlinear sigmoid function for the hidden layer intermediate signal to produce the hidden layer output signal. The nonlinear sigmoid function may include any known nonlinear sigmoid function, including a hyperbolic tangent function.

In determination block 810, the dual-technology communication device may determine whether the next layer in the multilayer perceptron neural network is the output layer. In response to determining that the next layer is not the output layer (i.e., determination block 810=“No”), the dual-technology communication device may provide each hidden layer output signal as the hidden layer input signal to the next hidden layer in block 812. The dual-technology communication device may continue to augment the hidden layer input signals with the weight factors in block 802 as described.

In response to determining that the next layer is the output layer (i.e., determination block 810=“Yes”), the dual-technology communication device may augment the hidden layer output signals with the weight factors in block 814 in a similar manner to the operations in block 802 as described. In block 816, the dual-technology communication device may execute a linear combination of the hidden layer output signals augmented by the weight factors as described for the hidden layer input signals in block 804.

In block 818, the dual-technology communication device may augment the linearly combined hidden layer output signals with a bias factor. In some embodiments, augmenting the combined hidden layer output signals with the bias factor may include executing a linear combination of the combined hidden layer output signals and the bias factor. Augmenting the combined hidden layer output signals with the bias factor may produce an estimated nonlinear interference of the victim signal caused by the aggressor signal(s).

FIG. 9 illustrates a method 900 for training weight factors for use in a multilayer perceptron neural network (e.g., 400 in FIG. 4) in a dual-technology wireless communications device in accordance with various embodiments. The method 900 may be executed in a computing device (e.g., 110, 120, 200 in FIGS. 1 and 2) using software, general purpose or dedicated hardware, or a combination of software and hardware, such as the general purpose processor 206 (FIG. 2), baseband processor 216, or the like. With reference to FIGS. 1-9, in block 902, the dual-technology communication device may select the weight factors for augmenting the hidden layer input signals. As described, in various embodiments, the weight factors may be determined at random, be preprogrammed, and/or trained. The weight factors may be selected from a range of values configured to reduce the error of the estimated nonlinear interference. A non-limiting example range includes values of about −0.5 to about 0.5.

In block 904, the dual-technology communication device may determine an error of the estimated nonlinear interference. Various known methods for determining the error of a function may be used to determine the error in block 904. As described, in some embodiments, the error calculation may be for the mean square error of the estimated nonlinear interference compared with the nonlinear interference signal caused by the aggressor signal(s).

In determination block 906, the dual-technology communication device may determine whether the estimation of the nonlinear interference is complete. In response to determining that the estimation of the nonlinear interference is incomplete (i.e., determination block 906=“No”), the dual-technology communication device may train the weight factors in block 908. In various embodiments, the weight factors may be trained using a variety of optimization algorithms, for example gradient decent, the Gauss-Newton algorithm, and the Levenberg-Marquardt algorithm. Training of the weight factors may be regressively executed to further reduce the error of the estimated nonlinear interference. Weight factors for each node of each layer of the multilayer perceptron neural network may be trained. Each weight factor may depend on the node and layer from which the hidden layer input signal originates and terminates. In other words, each weight for augmenting a hidden layer input signal may be trained using the pervious weight factor for augmenting a hidden layer input signal originating from a same first node and first layer, and being provided to a same second node and second layer. The dual-technology communication device may continue selecting weight factors for augmenting the hidden layer inputs signals in block 902 in which the selection may include the newly or additionally trained weight factors.

In response to determining that the estimation of the nonlinear interference is complete (i.e., determination block 906=“Yes”), the dual-technology communication device may determine whether the nonlinear interference cancellation exceeds an efficiency threshold in determination block 910. The determination of whether the nonlinear interference cancellation exceeds the efficiency threshold may be a measure of whether the nonlinear interference is sufficiently cancelled for the dual-technology communication device to decode and use the victim signal. In some embodiments, the efficiency threshold may be based on the error value determination of the nonlinear interference in block 904, in which the error level may be compared to an acceptable error level. In some embodiments, the efficiency threshold may be based on a success rate for decoding and using the victim signal. In response to determining that the nonlinear interference cancellation does not exceed the efficiency threshold (i.e., determination block 910=“No”), the dual-technology communication device may continue to train the weight factors in block 908. Training the weight factors may reduce the amount of error in the estimated nonlinear interference so that the cancellation of the estimated nonlinear interference may result in greater success of decoding and using the victim signal.

In response to determining that the nonlinear interference cancellation does exceed the efficiency threshold (i.e., determination block 910=“Yes”), the dual-technology communication device may reuse the weight factors for subsequent estimation and cancellation of the nonlinear interference in block 912. As described, the dual-technology communication device may not always train the weight factors when estimating the nonlinear interference. The nonlinear interference caused by the one or more aggressor signals may vary by different amounts under various conditions. In some embodiments, the variation in the nonlinear interference may be small enough that the trained weight factors may result in a sufficiently accurate estimated nonlinear interference that further training is unnecessary. Determining when to train the weight factors or reuse the weight factors may be based on one or more criteria, including time, measurements of the aggressor signal(s), victim signal quality, and nonlinear interference noise cancellation efficiency, for example including error of the estimated nonlinear interference and/or success of decoding and using the victim signal.

In some embodiments, the method 900 may be executed at various times before, during, or after the execution of the method 700 and the method 800. For example, the method 900 may be executed to calculate at least some of the weight factors before they are used to augment the hidden layer input signals in blocks 804 and 816. In some embodiments, certain blocks of the method 900 may not be executed contiguously, and may be executed interspersed with the blocks of the methods 700, 800.

In some embodiments, the method 900 may also be executed for the bias factors in place of the weight factors. In some embodiments, the bias factors may be included in the weight factors.

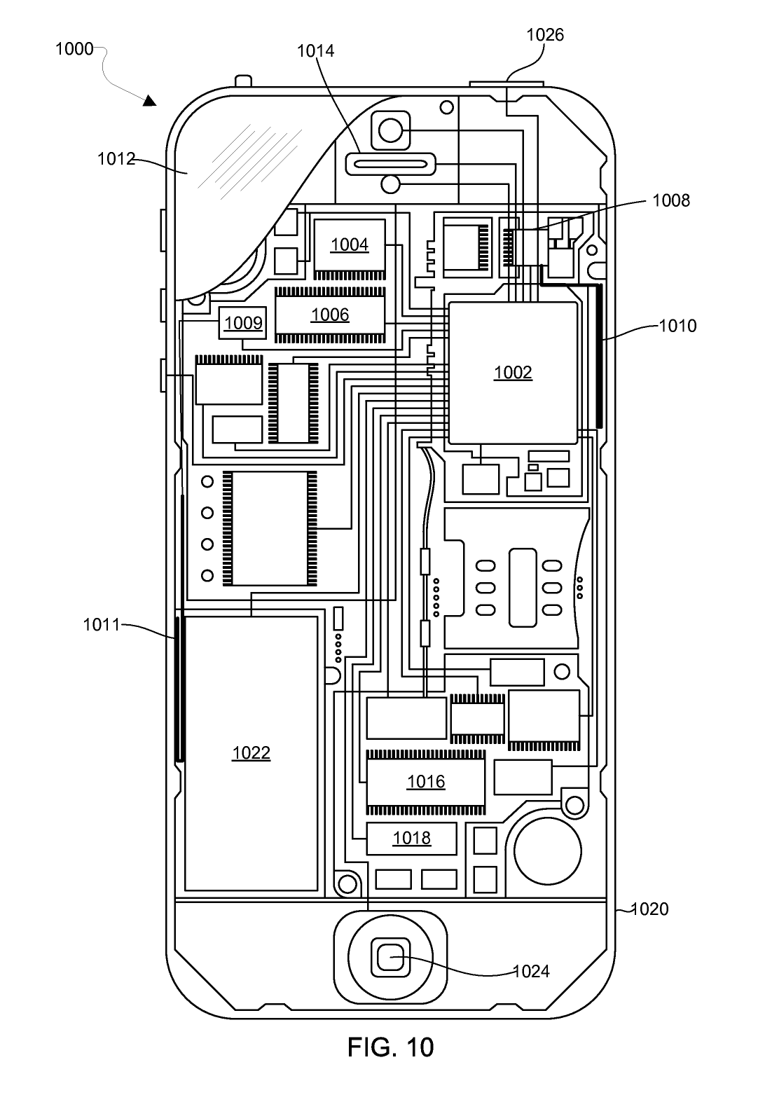

FIG. 10 illustrates an exemplary dual-technology communication device 1000 suitable for use with the various embodiments. The dual-technology communication device 1000 may be similar to the multi-technology device 110, 120, 200 (e.g., FIGS. 1 and 2). With reference to FIGS. 1-10, the dual-technology communication device 1000 may include a processor 1002 coupled to a touchscreen controller 1004 and an internal memory 1006. The processor 1002 may be one or more multicore integrated circuits designated for general or specific processing tasks. The internal memory 1006 may be volatile or non-volatile memory, and may also be secure and/or encrypted memory, or unsecure and/or unencrypted memory, or any combination thereof. The touchscreen controller 1004 and the processor 1002 may also be coupled to a touchscreen panel 1012, such as a resistive-sensing touchscreen, capacitive-sensing touchscreen, infrared sensing touchscreen, etc. Additionally, the display of the dual-technology communication device 1000 need not have touch screen capability.

The dual-technology communication device 1000 may have two or more cellular network transceivers 1008, 1009 coupled to antennae 1010, 1011, for sending and receiving communications via a cellular communication network. The combination of the transceiver 1008 or 1009 and its associated antenna 1010 or 1011, and associated components, is referred to herein as a radio frequency (RF) chain. The cellular network transceivers 1008, 1009 may be coupled to the processor 1002, which is configured with processor-executable instructions to perform operations of the embodiment methods described above. The cellular network transceivers 1008, 1009 and antennae 1010, 1011 may be used with the above-mentioned circuitry to implement the various wireless transmission protocol stacks and interfaces. The dual-technology communication device 1000 may include one or more cellular network wireless modem chips 1016 coupled to the processor and the cellular network transceivers 1008, 1009 and configured to enable communication via cellular communication networks.

The dual-technology communication device 1000 may include a peripheral device connection interface 1018 coupled to the processor 1002. The peripheral device connection interface 1018 may be singularly configured to accept one type of connection, or may be configured to accept various types of physical and communication connections, common or proprietary, such as USB, FireWire, Thunderbolt, or PCIe. The peripheral device connection interface 1018 may also be coupled to a similarly configured peripheral device connection port (not shown).

The dual-technology communication device 1000 may also include speakers 1014 for providing audio outputs. The dual-technology communication device 1000 may also include a housing 1020, constructed of a plastic, metal, or a combination of materials, for containing all or some of the components discussed herein. The dual-technology communication device 1000 may include a power source 1022 coupled to the processor 1002, such as a disposable or rechargeable battery. The rechargeable battery may also be coupled to the peripheral device connection port to receive a charging current from a source external to the dual-technology communication device 1000. The dual-technology communication device 1000 may also include a physical button 1024 for receiving user inputs. The dual-technology communication device 1000 may also include a power button 1026 for turning the dual-technology communication device 1000 on and off.

The foregoing method descriptions and the process flow diagrams are provided merely as illustrative examples and are not intended to require or imply that the steps of the various embodiments must be performed in the order presented. As will be appreciated by one of skill in the art the order of steps in the foregoing embodiments may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the various embodiments may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In one or more exemplary embodiments, the functions described may be implemented in hardware, software, firmware, or any combination thereof. If implemented in software, the functions may be stored as one or more instructions or code on a non-transitory computer-readable storage medium or non-transitory processor-readable storage medium. The steps of a method or algorithm disclosed herein may be embodied in a processor-executable software module which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

What is claimed is:

1. A method for managing interference in a multi-technology communication device, comprising:
receiving aggressor signals at an input layer of a multilayer perceptron neural network;
augmenting the aggressor signals with a weight factor at a first hidden layer of the multilayer perceptron neural network;
executing a linear combination of the augmented aggressor signals at the first hidden layer;
executing a nonlinear sigmoid function for the combined aggressor signals at the first hidden layer to produce a hidden layer output signal;
augmenting the hidden layer output signal with a weight factor at an output layer of the multilayer perceptron neural network; and
executing a linear combination of augmented hidden layer output signals at the output layer to produce an estimated nonlinear interference.

2. The method of claim 1, further comprising:
training weight factors to reduce an error of the estimated nonlinear interference.

3. The method of claim 2, further comprising:
determining an error of the estimated nonlinear interference;
determining whether the error of the estimated nonlinear interference exceeds an efficiency threshold; and
cancelling the estimated nonlinear interference from a victim signal.

4. The method of claim 3, wherein:
training weight factors to reduce an error of the estimated nonlinear interference comprises training weight factors in response to determining that the error of the estimated nonlinear interference exceeds the efficiency threshold, and
cancelling the estimated nonlinear interference from a victim signal comprises cancelling the estimated nonlinear interference from the victim signal in response to determining that the error of the estimated nonlinear interference does not exceed the efficiency threshold.

5. The method of claim 3, further comprising selecting the weight factors to reduce an error of the estimated nonlinear interference.

6. The method of claim 5, wherein selecting the weight factors to reduce an error of the estimated nonlinear interference comprises selecting the weight factors used for a previous determination of a previous estimated nonlinear interference for a previous victim signal within a predetermined time period.

7. The method of claim 2, wherein training weight factors to reduce an error of the estimated nonlinear interference comprises using a Gauss-Newton algorithm to train the weight factors.

8. The method of claim 2, wherein training weight factors to reduce an error of the estimated nonlinear interference comprises using a Levenberg-Marquardt algorithm to train the weight factors.

9. The method of claim 1, wherein executing a linear combination of the augmented aggressor signals at the first hidden layer comprises executing a linear combination of the combined aggressor signals and a bias factor at the first hidden layer.

10. The method of claim 1, wherein executing a linear combination of augmented hidden layer output signals at the output layer to produce an estimated nonlinear interference comprises executing a linear combination of the combined hidden layer output signals and a bias factor at the output layer.

11. The method of claim 1, further comprising cancelling the estimated nonlinear interference from a victim signal.

12. The method of claim 11, further comprising decoding the victim signal after cancelling the estimated nonlinear interference from the victim signal.

13. The method of claim 1, further comprising:
augmenting hidden layer output signals with a weight factor at a second hidden layer of the multilayer perceptron neural network;
executing a linear combination of the augmented hidden layer output signals at the second hidden layer; and
executing a nonlinear sigmoid function for the combined hidden layer output signals at the second hidden layer to produce a hidden layer output signal.

14. A multi-technology communication device, comprising:
a processor configured with processor-executable instructions to:
receive aggressor signals at an input layer of a multilayer perceptron neural network;
augment the aggressor signals with a weight factor at a first hidden layer of the multilayer perceptron neural network;
execute a linear combination of the augmented aggressor signals at the first hidden layer;
execute a nonlinear sigmoid function for the combined aggressor signals at the first hidden layer to produce a hidden layer output signal;
augment the hidden layer output signal with a weight factor at an output layer of the multilayer perceptron neural network; and
execute a linear combination of augmented hidden layer output signals at the output layer to produce an estimated nonlinear interference.

15. The multi-technology communication device of claim 14, wherein the processor is further configured with processor-executable instructions to:
train weight factors to reduce an error of the estimated nonlinear interference.

16. The multi-technology communication device of claim 15, wherein the processor is further configured with processor-executable instructions to:
determine an error of the estimated nonlinear interference;
determine whether the error of the estimated nonlinear interference exceeds an efficiency threshold; and
cancel the estimated nonlinear interference from a victim signal.

17. The multi-technology communication device of claim 16, wherein the processor is further configured with processor-executable instructions to:
train weight factors to reduce an error of the estimated nonlinear interference comprises training weight factors in response to determining that the error of the estimated nonlinear interference exceeds the efficiency threshold, and
cancel the estimated nonlinear interference from a victim signal comprises cancelling the estimated nonlinear interference from the victim signal in response to determining that the error of the estimated nonlinear interference does not exceed the efficiency threshold.

18. The multi-technology communication device of claim 16, wherein the processor is further configured with processor-executable instructions to:
select the weight factors to reduce an error of the estimated nonlinear interference.

19. The multi-technology communication device of claim 18, wherein the processor is further configured with processor-executable instructions to select the weight factors to reduce an error of the estimated nonlinear interference by selecting the weight factors used for a previous determination of a previous estimated nonlinear interference for a previous victim signal within a predetermined time period.

20. The multi-technology communication device of claim 15, wherein the processor is further configured with processor-executable instructions to train weight factors to reduce an error of the estimated nonlinear interference using a Gauss-Newton algorithm to train the weight factors.

21. The multi-technology communication device of claim 15, wherein the processor is further configured with processor-executable instructions to train weight factors to reduce an error of the estimated nonlinear interference using a Levenberg-Marquardt algorithm to train the weight factors.

22. The multi-technology communication device of claim 14, wherein the processor is further configured with processor-executable instructions to execute a linear combination of the augmented aggressor signals at the first hidden layer by executing a linear combination of the combined aggressor signals and a bias factor at the first hidden layer.

23. The multi-technology communication device of claim 14, wherein the processor is further configured with processor-executable instructions to execute a linear combination of augmented hidden layer output signals at the output layer to produce an estimated nonlinear interference by executing a linear combination of the combined hidden layer output signals and a bias factor at the output layer.

24. The multi-technology communication device of claim 14, wherein the processor is further configured with processor-executable instructions to cancel the estimated nonlinear interference from a victim signal.

25. The multi-technology communication device of claim 24, wherein the processor is further configured with processor-executable instructions to decode the victim signal after cancelling the estimated nonlinear interference from the victim signal.

26. The multi-technology communication device of claim 14, wherein the processor is further configured with processor-executable instructions to:
augment hidden layer output signals with a weight factor at a second hidden layer of the multilayer perceptron neural network;
execute a linear combination of the augmented hidden layer output signals at the second hidden layer; and
execute a nonlinear sigmoid function for the combined hidden layer output signals at the second hidden layer to produce a hidden layer output signal.

27. A multi-technology communication device, comprising:
means for receiving aggressor signals at an input layer of a multilayer perceptron neural network;
means for augmenting the aggressor signals with a weight factor at a first hidden layer of the multilayer perceptron neural network;
means for executing a linear combination of the augmented aggressor signals at the first hidden layer;
means for executing a nonlinear sigmoid function for the combined aggressor signals at the first hidden layer to produce a hidden layer output signal;
means for augmenting the hidden layer output signal with a weight factor at an output layer of the multilayer perceptron neural network; and
means for executing a linear combination of augmented hidden layer output signals at the output layer to produce an estimated nonlinear interference.

28. A non-transitory processor-readable medium having stored thereon processor-executable software instructions to cause a processor to perform operations comprising:
receiving aggressor signals at an input layer of a multilayer perceptron neural network;
augmenting the aggressor signals with a weight factor at a first hidden layer of the multilayer perceptron neural network;
executing a linear combination of the augmented aggressor signals at the first hidden layer;
executing a nonlinear sigmoid function for the combined aggressor signals at the first hidden layer to produce a hidden layer output signal;
augmenting the hidden layer output signal with a weight factor at an output layer of the multilayer perceptron neural network; and
executing a linear combination of augmented hidden layer output signals at the output layer to produce an estimated nonlinear interference.
